(19) United States
(12) Patent Application Publication
(10) Pub. No.: US 2024/0046338 A1
(43) Pub. Date: Feb. 8, 2024

(54) SYSTEM FOR TRACKING ARTICLE LOCATION AND PROVIDING LOCATION INFORMATION

(71) Applicant: Kwon Suk KOH, Songpa-gu, Seoul (KR)

(72) Inventor: Kwon Suk KOH, Songpa-gu, Seoul (KR)

(21) Appl. No.: 17/049,463

(22) PCT Filed: May 3, 2019
(86) PCT No.: PCT/KR2019/005303

§ 371 Date: May 20, 2021

(30) Foreign Application Priority Data
May 11, 2018 (KR) 10-2018-0054045

(51) Int. Cl. G06Q 30/0601; G06Q 10/087; G06Q 30/02

(52) U.S. Cl. CPC G06Q 30/0639; G06Q 10/087; G06Q 30/0625; G06Q 30/0281

(57) ABSTRACT

An embodiment of the present invention relates to the system for providing location tracking and location information of goods, and the technical problem to be solved is to be able to provide the location information of items displayed in the store.

To this end, an embodiment of the present invention discloses the system for providing location tracking and location information of goods including the following;
A product display module in which the product display part with the shelf installed multi-level horizontally in the up and down direction is arranged in a plurality of horizontal or vertical rows; and
Product guide module that outputs location information of products displayed on the shelf by external input

### TECHNICAL FIELD

An embodiment of the present invention relates to a system for providing location tracking and location information of goods.

### BACKGROUND TECHNOLOGY

Finding the product what people want in a large store is not easy.

Conventionally, consumers should find and inquire store managers or guides directly. In terms of store management of large stores used by many people, guiding customers individually on the way to the de sired product will be costly.

### DETAILED DESCRIPTION OF THE INVENTION

### Technical Challenge

An embodiment of the present invention provides a system for providing location tracking and location information of goods displayed in a store.

One embodiment of the present invention guides the product location from the current location and provides a system for providing location tracking and location information of goods that can shorten the time it takes to find a desired product to a customer shopping in a store.

### Solution to Problem

The system for providing location tracking and location information of goods according to an embodiment of the present invention may include a product guide module that outputs the follows. A product display module in which the product display unit with the shelf installed multi-level horizontally in the up and down direction is arranged in a plurality of horizontal or vertical rows; and a product guide module that outputs the location information of products displayed on the shelf by external input.

The product guide module may include the following; A communication unit for transmitting and receiving the data with the management server; A information input unit configured to receive the search information of desired product from the outside through an input interface; A storage unit for storing the arrangement information of product display module, the location information of a product input by a manager or received from a management server, and the related search word information pre set to correspond to the search information of product; A information extraction unit for extracting the location information of a product corresponding to the search information of product; A information output unit that outputs a input interface to input the product search information, the location information of extracted product and a information output unit that outputs the audio information set to correspond to the location information; and A control unit for controlling the operation of each component constituting the product guide module by the execution of a preset search program.

A storage unit may include the following; The image, video, graphic, voice and category information of goods displayed on the product display module, and the related search word information set to be associated with the category information.

The system for providing location tracking and location information of goods may further include; A notification module for outputting the location information of each product in the corresponding area provided on the product display unit or the shelf to the outside.

The system for providing location tracking and location information of goods may further include; A communication module performing the transmission and reception of data between the notification module and management server provided on the product display unit or shelf.

### Effects of the Invention

The system for providing location tracking and location information of goods according to an embodiment of the present invention may provide the location information of items displayed in stores.

One embodiment of the present invention can guide the goods location from the current location, and can shorten the time to find a desired product for a customer shopping in a store.

### BRIEF DESCRIPTION OF FIGURES

FIG. 1 is a view schematically showing a system for providing location tracking and location information of goods according to an embodiment of the present invention.

FIG. 2 is a block diagram schematically illustrating a product guide module of FIG. 1.

FIGS. 3a and 3b are diagrams illustrating an example of location information of article through the information output unit of FIG. 1.

### BEST MODE FOR CARRYING OUT THE INVENTION

Terms used in this specification herein will be briefly described, and the present invention will be described in detail.

The terms used in the present invention have selected the general terms that are widely used now considering the function of present invention, but this can be changed depending on the intentions of skilled person engaged in this field, or precedents and emergence of new techniques. There are also terms chosen arbitrarily by the applicant in certain cases and the meaning is described in detail in the relevant part of the invention. Therefore, the term used in the present invention should be defined based on the meaning of the term and the contents throughout the present invention, not on the name of a simple term.

When a certain part is “includes” a certain component throughout the specification, it does not exclude other components, but means that other components can be further included, unless otherwise specified. A term of “_unit”, “module” described in the specification means one or more function or a unit that processes an operation and it can be implemented as in hardware or software or a combination of hardware and software.

The present invention will be described in detail so that it can be easily carried out by a person having ordinary knowledge referring to the accompanying drawings for the embodiment of the pre sent invention. The present invention may be embodied in many different forms, and the present invention is not limited to the embodiments described herein. Parts not related to the explanation are omitted to clarify the invention in the drawings. The similar part is marked with the similar sign of drawing throughout the specification.

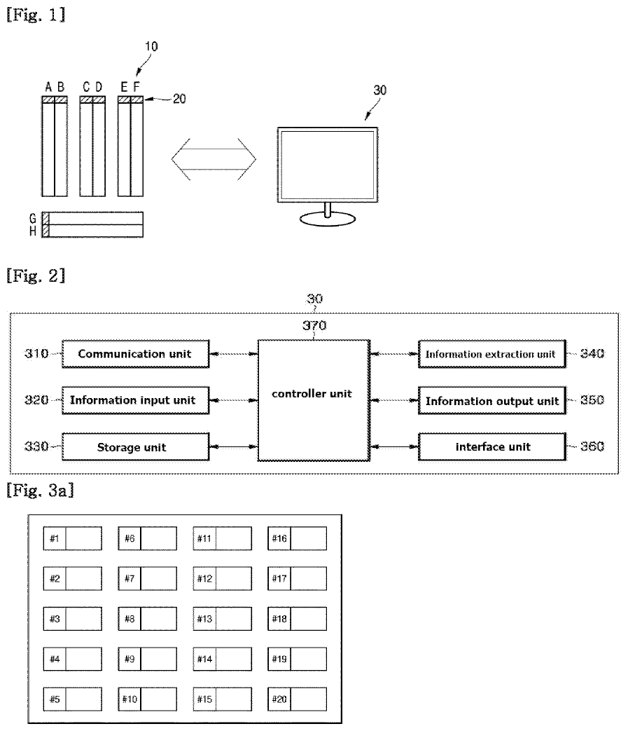

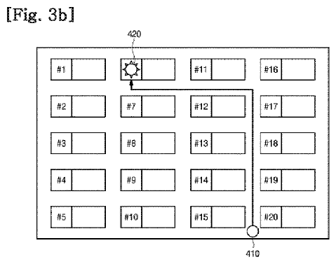

FIG. 1 is a view schematically showing a system for providing location tracking and location information of goods according to an embodiment of the present invention. FIG. 2 is a block diagram schematically illustrating a product guide module of FIG. 1. FIGS. 3a and 3b are diagrams illustrating an example of location information of an article through the information output unit of FIG. 1.

As shown in FIG. 1, the system for providing location tracking and location information of goods according to one embodiment of the present invention is a system that displays or outputs the corresponding location after tracks the goods location placed on the store shelves of convenience store, hypermarket, cigarette display and burning (building materials or household goods), etc, and includes a product's display module (10) and guide module (30). The system for providing location tracking and location information of goods according to an embodiment of the present invention may further include a notification module (20) and a communication module (not shown).

The goods display unit (A, B, C, D, E, F, G, H) with the shelf installed multi-level horizontally in the up and down direction is arranged in a plurality of horizontal or vertical rows in the product display module (10), For example, the shelves in the space or case installed the tempered glass or entire wall on the front install multi-level horizontally in the up and down direction in the product display module (10),

At one side of the product display unit, a customer selects the product or a notification module may (20) can be provided for to output the location information of each product in a corresponding area to the outside.

A communication module (not shown) to transmit and receive the data between the notification module (20) and management server may be further provided at one side of the product display unit.

The communication module (not shown) may be a short-range communication module for the communication between the notification module (20) and management server.

the communication module (not shown) may communicate with the management server through the network. For example, the communication module (not shown) can communicate with the management server using various service protocols as follows; TCP/IP (Transmission Control Protocol/Internet Protocol), HTTP (HyperText Transfer Protocol), HTTPS (Hypertext Transfer Protocol over Secure Socket Layer), SOAP (Simple Object Access Protocol), XMLRPC (XML Remote Procedure Call), etc.

The product guide module (30) is a device that outputs the location information of products displayed on shelves by external input, and includes a communication unit (310), an information input unit (320), a storage unit (330), an information extraction unit (340), an information output unit (350), and a control unit (360) as shown in FIG. 2.

The configuration of product guide module (30) shown in FIG. 2 is an example, and the product guide module (30) may equip only some of the modules shown in FIG. 2 and/or may additionally equip other modules essential for its operation.

The communication unit (310) is a communication module (not shown) and/or a device for transmitting and receiving the data with the management server, and may be a wireless communication module such as WiFi, ZigBee, and Bluetooth.

Also, the communication unit (310) may transmit the search information to the management server, and receive the location information and UI information of the product corresponding to the search information from the management server

The information input unit (320) receives the search information of desired product from the outside through an input interface.

The information input unit (320) may be equipped with an information input unit in the form of a touch screen separately from the user interface unit, or may have in one configuration with the user interface unit.

The information input unit (320) may receive a user command for operating a specific button provided on a UI screen for a search product provided on the information output unit (350) under the control of controller unit (370). In this case, the specific button may be provided in a state including a related search word, and if a specific button is touched, it may b e designed to output the corresponding content as a voice.

When a method of providing a UI corresponding to a search product according to an embodiment of the present invention is provided in a specific application form, the information input unit (320) may receive a user command for manipulating the corresponding application.

The information input unit (320) may have a microphone to be able to utilize for the information search by converting additionally user's voice or other sounds into audio data. The control unit (370) may provide as searching and extracting the location information of corresponding product using the user's voice input through the microphone as the product search request information. The information input unit (320) may provide as searching and extracting the location information of corresponding product after automatically or manually recognizing various national languages input through the microphone. In this case, when the voice input through the microphone is not recognized in the automatic mode, the information input unit may display to the corresponding country language mode after switch to the manual mode, and recognize the voice in the country language mode selected by the user.

The information input unit (320) can have buttons of various types like mechanical buttons, touch pads and wheels, etc. formed in an arbitrary area of the front, side and rear part of the main body exterior, etc. of the product guide module (30) and use as an information input means.

The storage unit (330) is a storage medium for storing the arrangement information of product display module (10), the location information of product input by the administrator or received from the management server and the related search word information set in advance to correspond to the product search information, and can be implemented as a memory or HDD (Hard Disk Drive). For example, the storage unit (330) may have a ROM for storing a program for performing an operation of control unit (370), and a RAM for temporarily storing the data according to the operation perform of control unit (370), and also may further have an EEROM (Electrically Erasable and Programmable ROM) for storing various reference data.

The storage unit (330) may store various UI spec information displayed on the information output unit (350). The UI spec here can be the UI window, and the button size, position, color and type (image, text, etc.) disposed within the UI window.

In some cases, the storage unit (330) may store a UI component corresponding to a preset product or place category. Here, the UI component may be various UI menus such as an image item, a text item, and a link item, etc. constituting the UI screen.

The storage unit may (330) store the following items; Image, video, graphic, voice and category information of products displayed in the product display module (10), and related search word information set to be related to the category information.

The storage unit (330) manages the information that matches the product location and the location of shelf where the product is located, and matches the identification number of product with the identification number of display, and is determined the product location according to each identification number. Accordingly, if the identification number of product for a specific product name is known, the identification number of display rack can be known, and the product location according to the identification number of display rack can be known. If the location of product is known, people can know the location of shelf where the product is located, so people can eventually know the location of product.

The information extraction unit (340) extracts the product location information corresponding to the product search information in the storage unit (330) through the control unit (370), and provides it to the information output unit (350).

The information extraction unit (340) extracts the location information of the product from the product search information entered by the user or directly from the storage unit (330), or generates search request message about a product location input by the user, and transmits it to the management server through the communication unit (310), and receives the product location information in the management server through the communication unit (310). ‘Product search information’ means the information input by a user to search for a location of a specific product in a store. The product search information may be a specific product name that the user wants to find, or a search keyword for searching a specific product. For example, when a user wants to find the location of a specific cigarette's brand in a store, the product search information may be ‘a product name’ of a specific cigarette's brand. Product search information may be ‘cigarettes’, which are the search keywords for cigarettes of a specific brand. A specific product name is managed by matching with the identification number of product.

The information output unit (350) is a device that outputs an input interface into which product search information is input, the location information of extracted product and the audio information set to correspond to the location information, and may be implemented as the following, but is not limited thereto; Application execution screen including various objects such as images, videos, text, etc., and GUI (Graphic User Interface) Screen containing LCD (Liquid Crystal Display Panel), OLED (Organic Light Emitting Diodes). The information output unit (350) may be implemented in the form of a touch pad and a touch screen forming a layer structure. The information output unit (350) may be a speaker device that outputs not only various audio data but also various notification sounds or voice messages.

For example, the information output unit (350) may provide a UI screen corresponding to the product by using the information obtained from the management server. The information output unit (350) may provide a UI screen corresponding to the category to which the product belongs based on information obtained from the management server. The UI screen is a screen for providing the related information of product to user, and may be provided in various forms according to the information received from the management server. To this end, the information output unit (350) may perform for searching the internal data based on the information received from the management server, or transmit the received information to the management server (not shown) and receive the information corresponding from the management server (not shown).

As shown in FIG. 3a, the information output unit (350) overlaps the location of the extracted or received product on the map, and generates and displays the displayed product location information. For example, the indication information of product location may display a product location by expressing a corresponding product image on a map to blink. The indication information of product location may indicate the product location by expressing the corresponding product image larger than other product images on the map. The display method of product location is not limited thereto, and if it's a way to highlight the location of a specific product on the map, it may be included all here.

As shown in FIG. 3b, the information output unit (350) calculates a path from the current location to the product location based on the location of extracted or received product, and generates and displays an image displaying this. For example, the path from the user's current location to the product location represents the current location of product guidance module (30) as a starting point (410), and represents the product location as the destination point (420) on the map. The path from the start point (410) to the destination point (420) can be marked with a straight line including arrows. The path from the start point (410) to the destination point (420) can be the shortest route The method of displaying the path from the user's current location to the product location is not limited thereto, and any method of displaying the path from the user's current location to the product location on the map in a way that stands out may be included all here.

The information output unit (350) makes it possible to identify the location of the item as making a light come on at the display location of the item (so that the light-emitting bulb located on the displayed product is lit), and at the same time as the light comes on, user can hear a confirmation sound from the speaker where the item and bulb is located. or, user can hear it sound only for confirmation sound at corresponding location without a light.

The information output unit (350) may generate GUI of various types in order to implement a function of processing/generating various UI screens including images, texts, link information, etc. in 2D or 3D form. As described above, the UI screen may be a screen related to the information received through the communication with the management server. To this end, the information output unit (350) may include a function of performing the following tasks; 2D/3D transitions of UI elements, transparency, color, size, shape and position adjustment, highlights, animation effects, and more.

The control unit (370) controls the overall operation of each component constituting the product guide module (30) by executing a preset search program (I.e., communication unit (310), information input unit (320), storage unit (330), information extraction unit (340), information output unit (350)).

The control unit (370) may determine a category to which the product belongs based on the received product information. For example, when the product information about “cigarette name” or “cigarette type” is received, it may be determined that the corresponding product belongs to the tobacco category. Specifically, the control unit (370) may determine that the received product information corresponds to “cigarette name” or “cigarette type” based on the pre-stored information or information received from the management server. For example, if the product information includes information such as “Marlboro Red”, it may be determined that the corresponding information corresponds to the product “Cigarette”.

The information about the general name or brand name of each product is previously stored, or may be received from outside.

UI components for each category may be previously stored or may be received from outside. The control unit (370) may determine the UI component related to the determined category based on the pre-stored information, but when the corresponding information is not stored in the product guide module (30), the control unit may transmit the determined category information to the management server and may receive the UI component belonging to the corresponding category from the management server. Here, the management server may be implemented in the form of a cloud server that provides services for various pro ducts according to an embodiment of the present invention, but it is not limited thereto, and may be implemented as a server separately operated by a product provider providing each product.

Here, each UI component may include at least one of the following; Images and texts information related to products, and link information that provides the information related to external objects. For example, in the case of the above-described “home appliance category”, the product images are provided in the images form, and product name, price, product spec and free gift information are provided in the text form.

The above-described operation of the control unit (370) may be performed by a program stored in the storage unit (330). Various data may be stored in the storage unit (330) as follows; O/S (Operating System) software module to drive product guidance module (30), various applications and various data and contents input or set during application execution etc.

If the providing service of product location information according to the present invention is implemented in the form of an application, which is software directly used by the user on the OS, the application may be stored. In this case, the application may be provided in the form of an icon interface on the screen of the product guide module (30), but is not limited thereto.

The controller unit (370) controls generally the operation of product guide module (30) using various programs stored in the storage unit (330).

The control unit (370) may execute an application stored in the storage unit (330), and configure and display the execution screen, and play various contents stored in the storage unit (330). The control unit (370) may communicate with the management server through the communication unit (310).

Although not shown, the control unit (370) includes a RAM, a ROM, a main CPU, a graphic processing unit, an interface unit (360), and a bus.

RAM, ROM, main CPU, graphic processing unit and interface unit (360), etc. may be connected to each other through a bus.

The interface unit (360) is connected to the various components described above. One among the interfaces may be a network interface that is connected to an external device through a network.

The main CPU accesses the storage unit (330) and performs booting using the O/S stored in the storage unit (330). There are performed various operations using various programs, contents, and data, etc. stored in the storage unit (330).

The instruction set, etc. for booting the system is stored in the ROM. When the turn-on command is input and power is supplied, the main CPU copies the O/S stored in the storage unit (330) to RAM according to the instruction stored in the ROM and boot the system by executing O/S. When booting is complete, the main CPU copies various application programs stored in the storage unit (330) to RAM, and executes the application programs copied to the RAM, and perform various operations.

The graphic processing unit generates a screen including various objects such as icons, images, and text, etc. The graphic processing unit calculates attribute values such as coordinate values, shape, size, color, etc. to be displayed for each object according to the layout of the screen by using the control command received from the information input unit (320). The graphic processing unit generates screens of various layouts including objects based on the calculated attribute values, and the generated screens are displayed in the display area of the information output unit (350).

Although not shown in the figures, the product guide module (30) may include a sensing unit.

The sensing unit may detect various manipulations such as touch, pressure, and approach to the product guide module (30).

The sensing unit may include a touch sensor that senses a touch. The touch sensor may be implemented in a capacitive type or a pressure sensitive type. If a part of the user's body touches the surface of the information output unit (350), the capacitive type is a method of calculating touch coordinates by detecting micro-electricity generated in the user's body by using a dielectric coated on the surface of the information output unit (350). The pressure-sensitive type includes two electrode plates, and when the user touches the screen, the pressure-sensitive type is a method of calculating touch coordinates by sensing that the upper and lower plates of touched point are in contact and current flows. As described above, the touch sensor may be implemented in various forms.

For example, when a touch to a specific button provided on the UI screen is detected through the sensing unit, the controller unit (370) performs an operation corresponding to the function of the button, and when rotation from the vertical mode to the horizontal mode is sensed through the detection unit, the controller unit (370) may rescale or change the UI screen appropriately displayed for the vertical mode to be suitable for the landscape mode, and display it.

In this case, the UI screen corresponding to each of the vertical mode and horizontal mode can be changed through rescaling, but in some cases, it is also possible for the UI components constituting a UI screen corresponding to each of the vertical mode and the horizontal mode, and information about the size and position thereof to be set separately.

The control unit (370) may additionally provide a UI window in the horizontal mode. For example, if the UI window corresponding to a specific product in vertical mode rotate in a horizontal mode in condition displaying on and selecting a specific function button (for example, add to wish list) on the UI window, it is also possible to rescale and display the size of the UI window and additionally display a window related to the selected specific function button.

The notification module (20) is provided on the pro duct display unit or shelf, and is a device for outputting the location information of each product in a corresponding area to the outside, and may be in the screen form in which a touch input is possible or a speaker device that outputs the audio information. The communication module (not shown) is provided on the product display unit or shelf, and is a short-range communication module for transmitting and receiving the data between the notification module (20) and the management server.

The management server (not shown) stores various information in a database, and is a device that can provide various information according to the request of the product guide module (30), and as described above, can be at least one of a purchasable product and a terminal device provided in a specific place. Such a management server may be implemented as an external server provided separately from the product guide module (30), but may be implemented in the form of an embedded server inside the product guide module (30) in some cases.

The management server may communicate with a separate information providing server (not shown), and is also possible to deliver various information to the product guide module (30). The product information may be in various forms according to the type of product. For example, the product information may include various types of information as follows; name, code, type, size, and color of product, and address of related server, etc.

A sound-absorbing layer may be applied to the inside of the product guide module (30).

The felt constituting the sound-absorbing layer may be a needle punch felt. The types of fibers that make up the sound-absorbing layer made of needle punch felt are as follows; polyester fiber, nylon fiber, polypropylene fiber, acrylic fiber and natural fiber, etc.

It is preferable that the thickness of the sound-absorbing layer is 0.5 to 16 mm. If the thickness of sound-absorbing layer is less than 0.5 mm, the effect of the sufficient sound-absorbing layer is lost, and if the thickness of the sound-absorbing layer exceeds 16 mm, the height of the product guide module (30) is reduced, so that sufficient space for the product guide module (30) is not obtained, which is not preferable.

The unit weight of the sound-absorbing layer is preferably 5 to 500 g/m2. If it is less than 5 g/m2, a sufficient sound-absorbing effect cannot be obtained, and if it exceeds 500 g/m2, the light weight of the product guide module (30) cannot be secured, which is not preferable.

The fineness of fibers constituting the sound-absorbing layer is preferably in the range of 0.1 to 20 decitex. If it is less than 0.1 decitex, it is difficult to absorb of low-frequency noise, and cushioning property is also lowered, which is not preferable. If it exceeds 20 decitex, it is difficult to absorb of high-frequency noise, which is not preferable. Among them, the fineness of the fibers constituting the sound-absorbing layer is preferably in the range of 0.1 to 15 decitex.

If such a sound-absorbing layer is provided inside the product guide module (30), noise can be reduced when the product guide module (30) is driven.

The antifouling coating layer coating the antifouling coating composition may be formed in order to effectively prevent adhesion and removal of contaminants, on the outer surface of the product guide module (30)

The antifouling coating composition contains alkanolamide and amphopropionate in a molar ratio of 1:0.01 to 1:2 and the total content of alkanolamide and amphopropionate is 1 to 10% by weight compared to the total aqueous solution.

Alkanolamide and amphopropionate are preferably 1:0.01 to 1:2 as a molar ratio. When the molar ratio is out of the above range, there is a problem in that the coating property of substrate is deteriorated or the coating film is removed as moisture adsorption on the surface after application is increased.

Alkanolamide and amphopropionate are preferably 1 to 10% by weight in the aqueous solution of total composition.

If it is less than 1% by weight, there is a problem that the coatability of the substrate is deteriorated, and if it exceeds 10% by weight, crystal precipitation is likely to occur due to an increase in the coating film thickness.

Application of a spray is preferred as a method of applying the antifouling coating composition onto a substrate.

The final coating film thickness on the substrate is preferably 500 to 2000 Å, more preferably 1000 to 2000 Å. If the thickness of the coating film is less than 500 Å, there is a problem of deterioration in the case of high-temperature heat treatment, and if it exceeds 2000 Å, there is a disadvantage that crystal precipitation occurs on the coated surface.

The antifouling coating composition can be prepared by stirring after 0.1 mol of alkanolamide and 0.05 mol of amphopropionate are added to 1000 ml of distilled water.

Because the outer surface of the notification module (20) is coated with a fragrance material having a function of treating respiratory diseases, it is effective in relieving users' fatigue and improving health.

Functional oils may be mixed in the fragrance material.

The mixing ratio is 95 to 97% by weight of the fragrance and 3 to 5% by weight of the functional oil are mixed, and the functional oil is composed of 50% by weight of Tangerine oil and 50% by weight of Palmitoleic acid oil.

The functional oil is preferably mixed with 3 to 5% by weight of fragrance. If the mixing ratio of the functional oil is less than 3% by weight, the effect is insignificant, and when the mixing ratio of the functional oil exceeds 3 to 5% by weight, the function is not greatly improved, and the manufacturing cost is greatly increased.

The main chemical components of Tangerine oil among the functional oils is citronellol, linalool and cital, and has good effects in relieving stress through antiseptic, antispasmodic, and sedative action.

Palmitoleic acid oil is good for dry or aged skin due to its antioxidant activity, and has excellent effects on cell regeneration, sterilization, and skin inflammation treatment.

If these functional oils are coated on the outer surface of the notification module (20), it plays a role in contributing to users' fatigue recovery and health promotion

A discolored portion that changes color according to temperature may be applied to the outer surface of the case of the controller unit (370). When it reaches a predetermined temperature or higher, two or more temperature discoloration material whose color changes are applied to the case surface of the control unit (370), and are separated into two or more sections according to the temperature change, and stepwise temperature change can be seen in the discoloration portion. A protective layer is applied on the discolored portion to prevent damage to the discolored portion.

A temperature discoloration material having a discoloration temperature of or more and 60° C. or more may be applied and formed to the discolored portion. The discoloration portion is for detecting a change in temperature of the paint by changing color according to the case temperature of the controller unit (370).

When the temperature reaches a predetermined temperature or higher, a temperature discoloration material to change color may applied to the case surface of the controller unit (370), and be formed in the discoloration portion. The temperature discoloration material is generally composed of 1˜10 μm microcapsule structure, and can display as colored and transparent colors due to the bonding and separation according to temperature of electron donors and electron acceptors in microcapsules

Temperature discoloration material change color quickly, and can have various discoloration temperature such as 40° C., 60° C., 70° C., 80° C., etc. This discoloration temperature can be easily adjusted in several ways. Various types of temperature discoloration material can be used based on the principles of molecular rearrangement of organic compounds and spatial rearrangement of atomic groups.

To this end, the discoloration portion is coated with two or more temperature discoloration material having different discoloration temperatures, and is preferable to be formed by separating into two or more sections according to temperature changes. Temperature discoloration layer is preferable to use a temperature discoloration material having a relatively low discoloration temperature and a temperature discoloration material having a relatively high discoloration temperature, and more preferably, may be formed a discolored portion using a temperature discoloration material having a discoloration temperature of 40° C. or more and 60° C. or more.

Through this, the temperature change of the control unit (370) can be checked step by step so that the temperature change of the paint can be detected, and accordingly, the control unit (370) can be operated in an optimal state, and damage to the control unit (370) due to overheating can be prevented in advance.

Because the protective layer is applied on the discoloration portion, prevents damage to the discolored portion due to external impact, and is easy to check whether the discolored part is discolored, and it is preferable to use a transparent coating material having an insulation effect in consideration that the temperature discoloration material is weak to heat.

What has been described above is only one embodiment for implementing the system for providing location tracking and location information of goods according to the present invention and the present invention is not limited to the above embodiments. Anyone with ordinary knowledge in the field to which the invention pertains will have the technical spirit of the present invention to the extent that various changes can be implemented as claimed in the claims range of patent, and without departing from the gist of the present invention.

1. The system for providing location tracking and location information of goods, which includes the following: A product display module in which the product display unit with the shelf installed the multi-level horizontally in the up and down direction is arranged in a plurality of horizontal or vertical rows; and A product guide module that outputs the location information of products displayed on the shelf by external input.

2. In the claim 1, the product guidance module in the system for providing location tracking and location information of goods may include the following;
A communication unit for transmitting and receiving the data with the management server;
A information input unit configured to receive the search information of desired product from the outside through an input interface;
A storage unit for storing the arrangement information of product display module, the location information of product input by a manager or received from a management server, and the related search word information preset to correspond to the search information of product;
A information extraction unit for extracting the location information of product corresponding to the search information of product;
A information output unit that outputs input interface to input the search information of product, the location information of extracted product and a information output unit that outputs the audio information set to correspond to the location information; and
A control unit for controlling the operation of each component constituting the product guide module by the execution of preset search program.
The storage unit may include the image, video, graphic, voice and category information of goods displayed on the product display module, and the related search word information set to be associated with the category information.

3. In the claim 1, the system for providing location tracking and location information of goods may further include:
A notification module for output the location information of each product in the area provided on the product display unit or shelf to the outside;
And a communication module for performing the transmission and reception of data between the notification module and management server provided on the product display unit or shelf.
